(19) United States
(12) Patent Application Publication
(10) Pub. No.: US 2008/0190725 A1
(43) Pub. Date: Aug. 14, 2008

(54) Friction Clutch For at Least One Running Wheel of a Track-Bound Traction Vehicle

(75) Inventors: Klaus Joos, Sulzbach-Rosenberg (DE); Bernd Pfannschmidt, Rosstal (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 11/911,905

(22) PCT Filed: Apr. 7, 2006
(86) PCT No.: PCT/EP2006/061442

§ 371 Date: Oct. 18, 2007

(30) Foreign Application Priority Data
Apr. 18, 2005 (DE) 10 2005 017 819.7

(51) Int. Cl. F16D 13/00; B61F 3/00

(52) U.S. Cl. 192/70.11; 105/182.1

(57) ABSTRACT

A friction clutch for at least one running wheel (9) of a track-bound traction vehicle is disclosed. The running wheel (9) is secured to a shaft (16) and can be driven by a motor (1). The friction clutch has opposite, annular outer jaws formed by a portion (28) of the running wheel (9) and by a compression ring (17, 23) which is firmly fixed to the running wheel (9), a clamping ring (27) being clamped between the compression ring (17, 23) and the portion (28) of the running wheel (9). The invention provides a friction clutch which is easy to produce and easily accessible. Moreover, it allows maximum torque to be subsequently adjusted.

The invention relates to a friction clutch for at least one running wheel of a track-bound traction vehicle, wherein the running wheel is attached to a shaft and can be driven by a motor.

In electric drives of track-bound traction vehicles, three-phase asynchronous motors are used widely nowadays in conjunction with power converters. Faults in the control of the converter may cause the three-phase asynchronous motor to briefly generate very high braking torques which are a multiple of the maximum operating torque. This torque is also referred to as a peak transient torque. The jolting braking which is brought about causes a very high level of loading on the entire drive train.

In trains, drive shafts, which connect a drive which is mounted, for example, in a bogey or vehicle body, in accordance with the running wheels, are used to transmit the drive torque and also braking torque to the wheel set or the individual running wheels. In the case of drives with suspension, this axle clutch has to compensate relative movements between the wheel and drive, for example by means of steering clutches, multiplate clutches or denture clutches.

It is known to give the drive train in railway drives such generous dimensions that it withstands the number of loads due to the peak transient torque which are to be expected over its service life.

However, it is disadvantageous that the overdimensioning of the drive train leads to a considerably increased use of material and a correspondingly comparatively heavy weight of the drive train.

It is also known to limit the peak transient torque occurring in the drive train by means of a friction clutch whose breakaway torque is set to a value above the maximum operating torque. The known frictional clutches are used at the motor shaft or pinion shaft. In the case of an electrical short circuit, the clutch then slips briefly.

However, it is disadvantageous here that the known friction clutches have to be manufactured in a costly fashion from a large number of parts and are difficult to access for repairs or maintenance work due to their installation in the vicinity of the motor. Furthermore, the known friction clutches cannot be subsequently adjusted with respect to the maximum transmitted torque.

The invention is therefore based on the object of specifying a friction clutch which is easy to manufacture and easy to access. Furthermore, subsequent adjustment of the maximum torque is to be made possible.

This object is achieved according to the invention by means of a friction clutch for at least one running wheel of a track-bound traction vehicle, wherein the running wheel is attached to a shaft and can be driven by a motor, and the friction clutch has annular, outer jaws lying opposite one another, wherein the outer jaws of the friction clutch are formed from a part of the running wheel and a compression ring, wherein the compression ring is permanently connected to the running wheel, and a clamping ring is clamped in between the compression ring and the part of the running wheel.

This advantageously ensures that the friction clutch according to the invention is easy to manufacture since in contrast to a conventional flange screw connection it can optionally also be implemented with just one further part, the compression ring. A further advantage arises from the fact that the friction clutch at the running wheel is comparatively easier to access than a friction clutch which is installed on the motor shaft or pinion shaft. The clamping ring is accordingly a part of the axle clutch and in the case of an overload it can rotate with respect to the unit formed from the running wheel and compression ring. The running wheel can be driven by means of a traction drive via an axle clutch.

The running wheel can be driven by a motor via an axle clutch hollow shaft and/or an axle clutch joint which is connected to the running wheel. The clamping ring can then be a part of the axle clutch hollow shaft on the running wheel side or can be permanently connected to the axle clutch hollow shaft on the running wheel side. The axle clutch joint is then not required.

Alternatively it is also possible to conceive of the clamping ring being a part of the axle clutch joint on the running wheel side or being permanently connected to the axle clutch joint on the running wheel side. In this alternative case, the running wheel is connected to the axle clutch hollow shaft via the friction clutch and the axle clutch joint.

The drive train can advantageously be sprung in this way. The hollow shaft can also be made very short and in a borderline case on the running wheel side it can also be composed of just a connection to the axle clutch joint or of a clamping ring, and on the motor side it can be composed of a connection for the transmission of force. The drive train can therefore be used equally well in a wheel set drive and an individual wheel drive.

A further running wheel is advantageously attached to the shaft and then does not have to be driven separately and it is then also not necessary to provide any further friction clutch for said running wheel (wheel set drive).

The clamping ring is embodied according to the invention in such a way that it has parallel faces on the clamped-in sides or has a conical cross section. In both cases, it is advantageously ensured that comparatively large friction faces are available and said faces take up heat which is generated by friction so that a risk of overheating is prevented.

A further advantageous embodiment of the invention is obtained if further elements which have friction faces are provided between the compression ring and the clamping ring and/or between the running wheel and the clamping ring. These elements are then embodied as rings or are in the shape of brake blocks. This advantageously ensures that only these elements are subject to wear and not the compression ring or the running wheel.

Alternatively it is also possible to conceive of a friction lining or an antifriction coating agent being located on at least one of the clamping faces which are formed between the compression ring and clamping ring and between the running wheel and clamping ring.

The attachment of the compression ring is implemented according to the invention by means of a screw connection with self-aligning nuts with an oval cross section and driver pins. This ensures, on the one hand, secure attachment of the compression ring to the running wheel and, on the other hand, also easy disassembly for maintenance work. However, the attachment by means of screws advantageously permits subsequent adjustment of the maximum torque which is to be transmitted.

Self-aligning nuts are, however, not necessarily required if the components are made very rigid and are fabricated with tight tolerances so that only small deformations occur and said deformations can be absorbed by the thread play of the screw connection.

A further advantageous embodiment of the invention is obtained if the outer side of the compression ring is supported on the running wheel. The compression ring can then in fact also be embodied as a flexural bar. The compression ring then has a tapered portion between its outer side and its inner side so that the clamping ring is clamped in by the inner side of the compression ring. This advantageously ensures that the compression ring can yield at excessively high loads and damage is prevented.

Furthermore, the invention provides not only the clamping ring but also a centering ring which is permanently connected and which fits in a positively engaging fashion into a cut-out on the running wheel, and thus also centers the clamping ring in the outer jaws of the friction clutch. This advantageously ensures that the clamping ring is always held in an optimum fashion by the outer jaws of the friction clutch.

A further advantageous embodiment of the invention is obtained if, in addition to the clamping ring, sealing rings are provided so that the friction face is protected against moisture and therefore against corrosion.

The advantages mentioned above can then be implemented by virtue of the installation of the friction clutch according to the invention in a track-bound traction vehicle or in the bogey of a track-bound traction vehicle. In particular, the maintenance times of a track-bound traction vehicle can then be reduced since by virtue of the invention the friction clutch is easier to access because it is connected to the running wheel which is accessible from the outside.

The invention and further advantageous embodiments of the invention according to the features of the subclaims are explained in more detail below with reference to schematically illustrated exemplary embodiments in the drawing without restricting the invention to this exemplary embodiment; in the drawing:

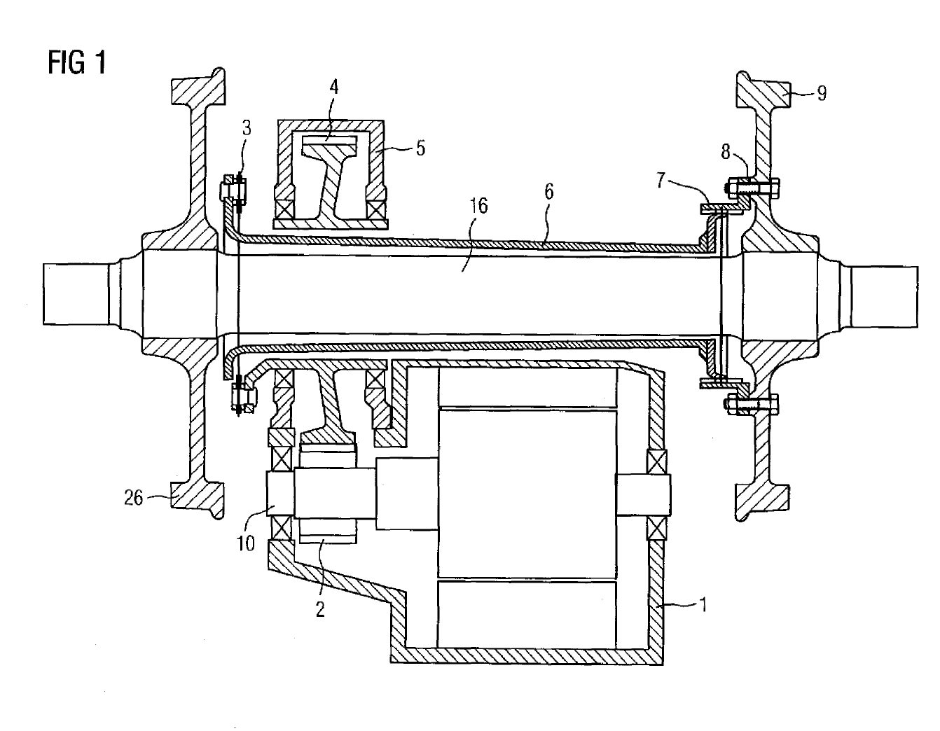

FIG. 1 shows a drive train of a track-bound traction vehicle;

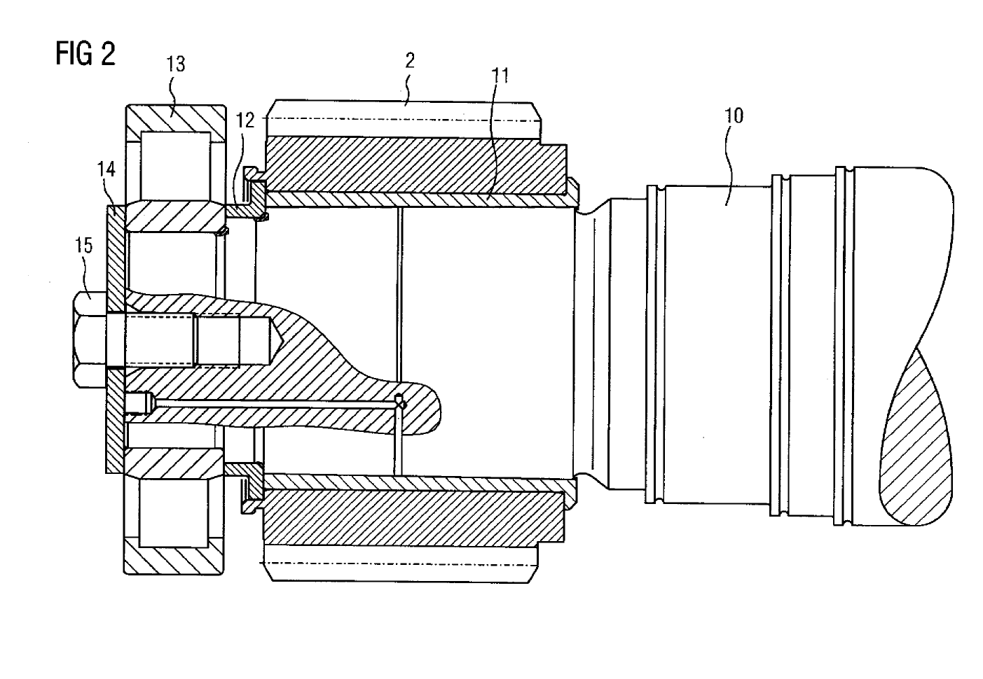

FIG. 2 shows a friction clutch on the motor shaft;

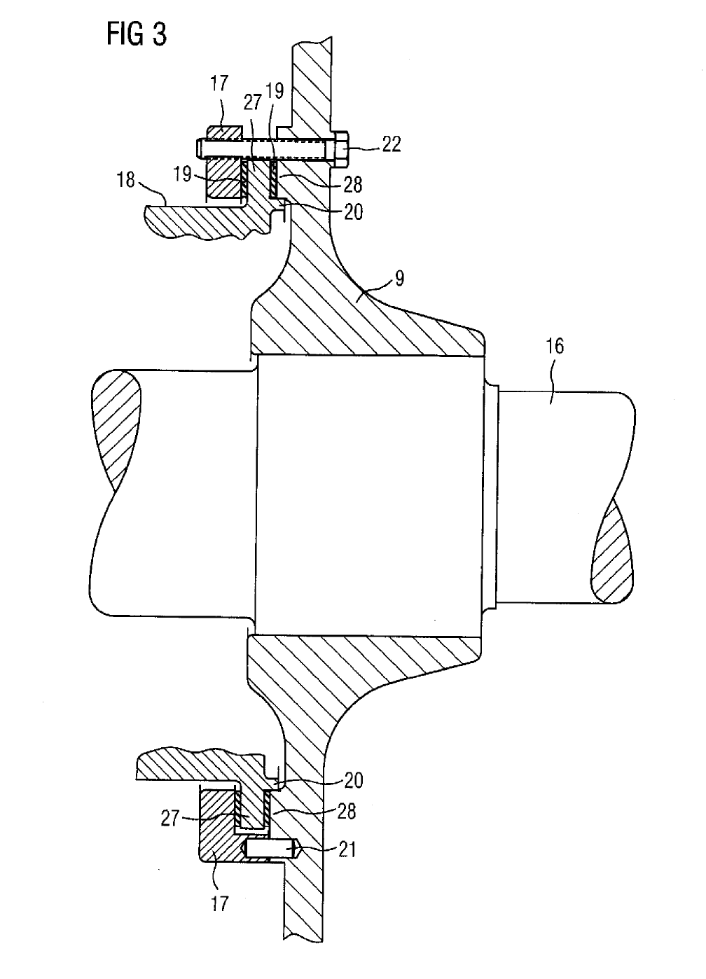

FIG. 3 shows a friction clutch according to the invention, and

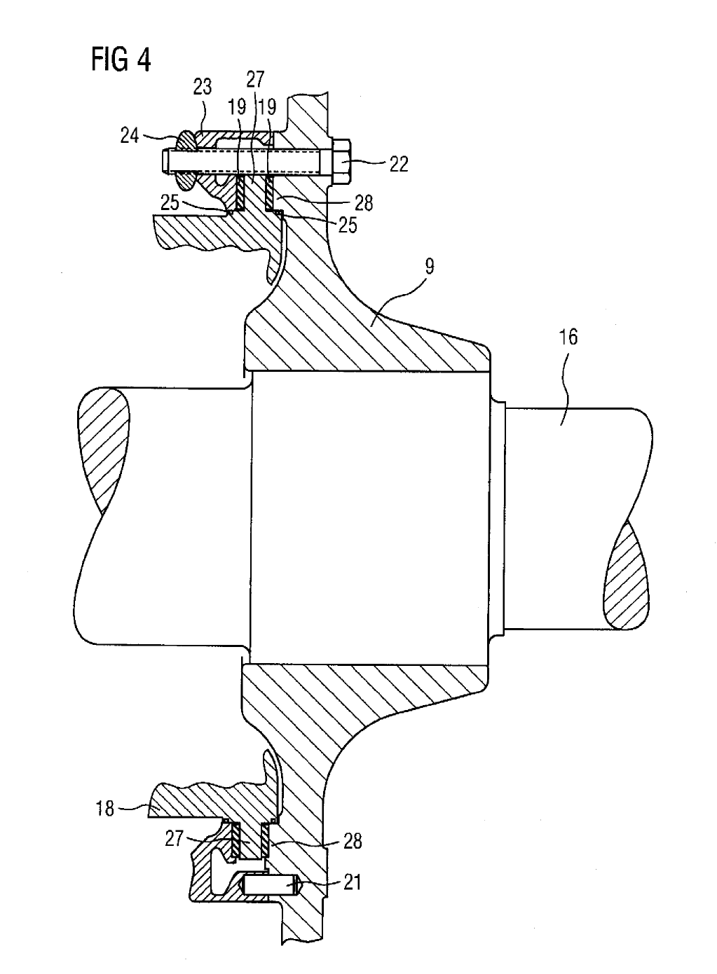

FIG. 4 shows a further exemplary embodiment of a friction clutch according to the invention.

FIG. 1 shows a drive train of a track-bound traction vehicle according to the prior art. A traction motor 1 drives a motor pinion 2 which is attached to the motor shaft 10. The motor pinion 2 is connected via its tooth edges to the large gearwheel 4 which is installed in a single-stage transmission 5. The large gearwheel 4 is connected via a drive side axle clutch joint 3 to the axle clutch hollow shaft 6 which is in turn connected to a wheel side axle clutch joint 7. The wheel side axle clutch joint 7 is attached to the running wheel 9 by means of a flange screw connection 8. The running wheel 9 is attached to a shaft 16, at whose other end a further running wheel 26 is provided. The axle clutch hollow shaft 6 also serves here to implement a suspension in which a rigid coupling between the traction motor and running wheels is not desired. In this prior art, the drive train must be overdimensioned so that the peak transient torque does not cause any damage.

FIG. 2 shows a friction clutch according to the prior art, which is mounted between the motor shaft 10 and the motor pinion 2. The main component of the friction clutch is the friction bushing 11 which permits the motor pinion 2 to slip with respect to the motor shaft 10 when an excessively high torque has to be transmitted. However, it is clearly not possible with such a friction clutch to subsequently adjust the maximum torque which is to be transmitted since said maximum torque depends substantially on the dimensioning of the components involved and is therefore fixed.

Furthermore, in such friction clutches it is necessary to take measures to prevent slipping or sliding of the friction bushing. For this purpose, a structure composed of a spacer bushing 12, a bearing 13, a securing plate 14 and a securing screw 15 is necessary.

FIG. 3 shows an exemplary embodiment of the friction clutch according to the invention. The friction clutch has annular protruding outer jaws lying opposite one another, the outer jaws of the friction clutch being formed from a part 28 of the running wheel 9 and a compression ring 17, and the compression ring 17 being permanently connected to the running wheel 9. In this context, a clamping ring 27 is clamped in between the compression ring 17 and the part 28 of the running wheel 9. The clamping ring 27 is part of a further element 18 which can correspond to the axle clutch joint 7 or else to an axle clutch hollow shaft 6 alone if the axle clutch joint 7 is eliminated. The part 28 of the running wheel 9 is formed on the running wheel 9 here, i.e. the part 28 and the running wheel 9 are integral. The part 28 can protrude here but this is not absolutely necessary. As is shown by FIG. 1 and FIG. 3, the running wheel 9 can be driven by a traction motor 1.

The shaft 16 can also be embodied as a stub axle. The running wheel 9 is then attached to a stub axle. That is to say two running wheels 9 which lie opposite one another are each attached to a separate stub axle. The stub axles are then mounted directly on the bogey.

The compression ring 17 is secured using screws 22 and by means of driver pins 21 and is attached to the running wheel 9. Optionally, friction linings 19 can be located on the clamping faces which are formed between the compression ring 17 and the clamping ring 27 and between the running wheel 9 and clamping ring 27.

Alternatively it is also conceivable for further elements which have friction faces to be provided between the compression ring 17 and clamping ring 27 and/or between the running wheel 9 and clamping ring 27. These elements may be, for example, brake blocks or further rings. Furthermore a centering ring 20 is provided in addition to the clamping ring 27 which fits in a positively engaging fashion into a cut-out on the running wheel 9. The centering ring 20 ensures that the clamping ring 27 is always guided in an optimum fashion between the outer jaws of the friction clutch.

If therefore a peak transient torque occurs, the clamping ring 27 slips briefly between the compression ring 17 and the part 28 of the running wheel 9. The clamping ring 27 is then held again by the compression ring 17 and the part 28 of the running wheel 9, and torque is transmitted without slip. In principle it is also conceivable for the friction clutch to be formed from a plurality of clamping rings 27, a plurality of compression rings 17 and the part 28 of the running wheel 9. In this case, the clamping rings 27 engage in the cut-outs which are formed by the compression rings 17 and the part 28 of the running wheel 9.

Furthermore, the compression ring 17 can also be replaced by at least one structure which clamps in the clamping ring 27 but which has a different shape.

FIG. 4 shows a further exemplary embodiment of a friction clutch according to the invention. A modified compression ring 23 has been used in FIG. 4. The compression ring 23 has a tapered portion on the side facing away from the running wheel 9 so that the clamping ring 27 is clamped in only by the inside of the compression ring 23 and the part 28 of the running wheel 9. The compression ring 23 is accordingly configured as a flexural bar and its outer side is supported on the running wheel 9. This advantageously ensures that the compression ring 23 can yield at excessively high loads and damage is prevented. Furthermore, self-aligning nuts 24 are used for the screw connection with the screws 22. In the exemplary embodiment in FIG. 4, the clamping ring 27 is sealed by means of two sealing rings 25 in order to protect against moisture or soiling. It is also conceivable for the region of the clamping ring to be covered by a hood in order to protect against moisture or soiling.

1.-21. (canceled)

22. A friction clutch for at least one running wheel of a track-bound traction vehicle, wherein the running wheel is attached to a shaft and can be driven by a motor, said friction clutch comprising:
a compression ring permanently connected to the running wheel;
annular, outer jaws arranged in opposite relationship and formed from a part of the running wheel and the compression ring; and
a clamping ring clamped in between the compression ring and the part of the running wheel.

23. The friction clutch of claim 22, further comprising an axle clutch hollow shaft via which the motor is able to drive the running wheel.

24. The friction clutch of claim 22, further comprising an axle clutch joint via which the motor is able to drive the running wheel, said axle clutch joint being connected to the running wheel via the friction clutch.

25. The friction clutch of claim 22, further comprising a further running wheel for attachment to the shaft.

26. The friction clutch of claim 23, wherein the clamping ring is a part of the axle clutch hollow shaft on a running wheel side or is permanently connected to the axle clutch hollow shaft on a running wheel side.

27. The friction clutch of claim 24, wherein the clamping ring is a part of the axle clutch joint on a running wheel side or is permanently connected to the axle clutch joint on a running wheel side.

28. The friction clutch of claim 27, further comprising an axle clutch hollow shaft via which the motor is able to drive the running wheel, wherein the running wheel is connected to the axle clutch hollow shaft via the axle clutch joint.

29. The friction clutch of claim 22, wherein the clamping ring has parallel faces on its clamped-in sides.

30. The friction clutch of claim 22, wherein the clamping ring has a conical cross section.

31. The friction clutch of claim 22, further comprising further elements which have friction faces and are positioned between the compression ring and the clamping ring and/or between the running wheel and the clamping ring.

32. The friction clutch of claim 22, further comprising a friction lining applied on a clamping face formed between the compression ring and the clamping ring and a clamping face between the running wheel and the clamping ring.

33. The friction clutch of claim 22, further comprising an antifriction coating agent applied on a clamping face formed between the compression ring and clamping ring and a clamping face between the running wheel and clamping ring.

34. The friction clutch of claim 22, further comprising at least one screw connection for securing the compression ring to the running wheel.

35. The friction clutch of claim 34, further comprising self-aligning nuts with an oval cross section for securing the screw connection.

36. The friction clutch of claim 22, further comprising at least one driver pin for additionally securing the compression ring.

37. The friction clutch of claim 22, wherein the compression ring has an outer side of the which is supported on the running wheel.

38. The friction clutch of claim 37, wherein the compression ring has a side which faces away from the running wheel and is configured as a flexural bar.

39. The friction clutch of claim 22, further comprising a centering ring associated to the clamping ring and fitting in a positively engaging fashion into a cut-out on the running wheel.

40. The friction clutch of claim 22, further comprising at least one sealing ring associated to the clamping ring to seal friction faces.

41. A bogey for a track-bound traction vehicle having at least one friction clutch which includes a compression ring permanently connected to a running wheel, annular, outer jaws arranged in opposite relationship and formed from a part of the running wheel and the compression ring, and a clamping ring clamped in between the compression ring and the part of the running wheel.

42. A track-bound traction vehicle having at least one friction clutch which includes a compression ring permanently connected to a running wheel, annular, outer jaws arranged in opposite relationship and formed from a part of the running wheel and the compression ring, and a clamping ring clamped in between the compression ring and the part of the running wheel.
